(19) United States
(12) Patent Application Publication
(10) Pub. No.: US 2024/0149607 A1
(43) Pub. Date: May 9, 2024

(54) Paint Roller Cover Squeegee and Paint Brush Holder Clamp

(71) Applicant: Robert J. Halvorsen, JR., Syracuse, NY (US)

(72) Inventor: Robert J. Halvorsen, JR., Syracuse, NY (US)

(21) Appl. No.: 17/981,564

(22) Filed: Nov. 7, 2022

(51) Int. Cl. B44D 3/00

(52) U.S. Cl. CPC B44D 3/006

(57) ABSTRACT

A paint roller squeegee removes excess paint from a paint roller cover. A circular squeegee ring has a round opening and a flat planar bottom surface. A handle projects from a proximal side of the circular ring and may be angled upward from the plane of the ring. A paintbrush holder for holding a paint brush is unitarily formed of an upper vertical arm with a paintbrush hang peg at its upper end, a lower arm that extends into a paint bucket or pail, and a bowed outer arm that extends over the bucket upper rim, around the bucket stabilizing rings and secures to the circular ridge at the top of the bucket; a lower end engages the bucket outer surface. The paintbrush holder keeps bristles in the paint, but off the bottom of the bucket. The squeegees and the paintbrush holder clamps can be formed of a suitable polypropylene.

The present invention concerns tools for use in painting with a brush or paint roller, to facilitate the painter's job both in painting a wall, ceiling or other article, and in cleaning up the painting tools. More specifically, the invention is directed to paint roller squeegees used in removing excess paint from the paint roller covers; to paint brush holders (or clamps) which can be securely fitted onto the rim of a standard paint bucket by snapping it over the bucket's rim, and to a set of these tools, that is, a plurality of paint roller squeegees, and a plurality of paint brush holders, being of sizes to accommodate an assortment of paint roller covers and paint brushes.

The squeegees are formed unitarily and of a suitable plastic so that they can remove excess paint from the roller cover in one pass or swipe. The squeegees can have different size squeegee rings so as to accommodate the most commonly used nap lengths.

The paint brush holders may be taller or shorter so as to accommodate paint brushes of different paint brush handles but permit the bristles to be suspended into the paint so they do not dry out when in use.

Both articles can be made of a polypropylene resin, which is durable, resistant to the components of the paint, and reasonably stiff, but yielding enough to flex onto the roller cover as need be or onto the paint bucket rim, and resistant to damage from impact.

### Brief Description of the Invention

The components of this invention are described briefly as follows:

### Squeegees

The squeegees are made from the same material as the paint brush holders, such as a polypropylene or polypropylene copolymer, to provide a superior balance of stiffness and impact strength, with resistance to breakage, and ultraviolet radiation, and impervious to mineral spirits, alcohol, and detergents, and will not alter the products they are designed to work with, e.g. paints, varnishes, and other coatings. The squeegees and brush holders can be made in any color, such as a bright blue.

The squeegees are designed to remove residual paint from the nap of paint roller covers quickly and efficiently. The embodiments as described here are intended for the one-and-one-half inch roller core cover, which is the most widely used diameter roller in the painting business. These may have different nap lengths, but the rollers with half-inch nap and three-eighth-inch nap are the two that are most widely used. The two roller squeegees disclosed here work on roller covers of all weaves and materials, such as nylon, polyester, or foam, and can accommodate rollers of any length (these rollers come in lengths of three inches to thirty six inches). The squeegees can clear off the residual paint with one easy swipe over the paint roller (as described shortly). The squeegees each have a circular ring or loop designed to accommodate all tight- and loose-woven nap rollers, and include a handle that is affixed to one side of the rim of the squeegee ring and is angled above the plane of the flat side of the ring. A portion of the handle near the ring serves as a thumb grip for precise handling for squeezing the paint from the roller cover.

The circular ring or loop has a flat bottom side which allows the paint to roll off the roller cover in one swipe with no splash or mess. The roller cover can be cleaned while it is still on the paint roller core, so that the roller cover does not have to be held on the rim of a paint can or bucket. Rather the free end of the roller is simply placed onto the paint roller tray, and the paint can be poured from there into the paint can or bucket. The paint roller handle can simply be placed through the round opening in the squeegee ring, and the squeegee moved along the roller frame to the cover. Then the roller free end can be placed onto the paint tray and by pushing the squeegee down, the painter quickly removers the paint from the roller cover in a single swipe.

The inside of the squeegee ring is slanted from a wider top to a narrower bottom edge where the sloping (frustoconic) surface meets the flat circular bottom side.

The roller squeegees of this invention avoid the problems of current techniques such as using a curved side of a paint stirrer stick to squeeze out the residual paint, and require multiple swipes.

### Paintbrush Holders

The brush holders or brush savers are designed as one-piece clips or clamps, and they snap in place onto a standard plastic paint bucket. The brush holders each have a vertical post or arm that has a horizontal peg near its top end. The peg accommodates the hole through the paint brush handle that is near the handle's top or upper end. The paintbrush holders are designed to fit over the upper rim of the bucket. The paint brush holder is designed as a brush saver, and holds the paintbrush bristles partially submerged in the paint in the bucket when the paintbrush is suspended from the peg at the upper end of the holder.

The brush holder(s) are molded of a superior polypropylene copolymer which has an optimal balance of stiffness and strength. The holder can be snapped into place on the top rim of the bucket, and will hold itself and any suspended paintbrush in place even when the bucket is picked up and moved around. This design ensures a steady grip of the paintbrush holder onto the bucket (and brush) when the bucket is picked up and carried up or down a ladder. The polymer used in the paintbrush holder(s) provides an optimal balance of stiffness and impact strength, and can have optimal color such as a bright blue. The plastic material is resistant to ultraviolet radiation and to any of the solvents commonly used with paints and other coatings and finishes.

The described embodiments of the paintbrush holder fit onto a standard, commercially available two-gallon plastic paint bucket. These are the primary paint containers used in residential and commercial painting. The two-gallon buckets have a one-eighth inch top ring that is adapted for accepting a bucket lid. The bucket also has a number of stabilizer rings spaced below the upper rim and top reinforcing ring. The brush holders are designed to engage the top ring and to clear all of the stabilizer rings, so that the brush holders attach and detatch quickly and easily, and have a stable attachment onto the paint bucket. Once clipped onto the paint bucket, the paintbrush holder will not detatch when the bucket is bumped, jostled, moved, or carried up or down a ladder. No further clips, clamps or magnets are needed, the peg (or hook) is always ready for hanging the paint brush. The paint brush holders will not interfere with normal painting operations. The upper arms (e.g., risers or posts) can be in different sizes so as to accommodate normal short-handle brushes in a range from 9 inches to 10-½ inches in length and 1 inch to 4 inches in bristle width. A taller version can be used brushes in a range from 11 inches to 12-½ inches in length and 1 to 4 inches in bristle width. These brush holders as used with the paint brushes (of long or short length handles) allow the respective brush or brushes to be suspended with the tips of the bristles in the paint, for both flat edge and angled brushes.

### BRIEF DESCRIPTION OF THE DRAWING FIGS

FIG. 1 is a perspective view or a paint roller squeegee according to an embodiment of this invention.

FIGS. 2 and 3 are a top plan view and a medial elevational cross-section thereof.

FIGS. 4, 5, and 6 are a perspective, a top plan view, and a medial cross sectional view of a similar paint roller squeegee according to an embodiment of this invention.

FIGS. 7A, 7B, 7C and 7D are perspective views for sequentially showing the process of using the squeegee of this invention for removing residual paint from a paint roller cover.

FIGS. 8 and 9 are a perspective view and a side elevational view, respectively, of an embodiment of the paint brush holder of the present invention, for use with longer handled paint brushes.

FIGS. 10 and 11 are a perspective view and a side elevational view, respectively, of an embodiment of the paint brush holder of the present invention, for use with shorter handled paint brushes.

FIGS. 12A, 12B, 12C, and 12D are views showing the sequence of installing one of the paint brush holders of this invention onto the open top edge of a common plastic paint pail.

FIG. 12E shows the paint brush holder and a paint brush suspended from it, with the brush's bristles immersed in the paint in the bucket (a portion of the bucket is shown cut-away).

### DETAILED DESCRIPTION OF THE PREFERRED EMBODIMENTS

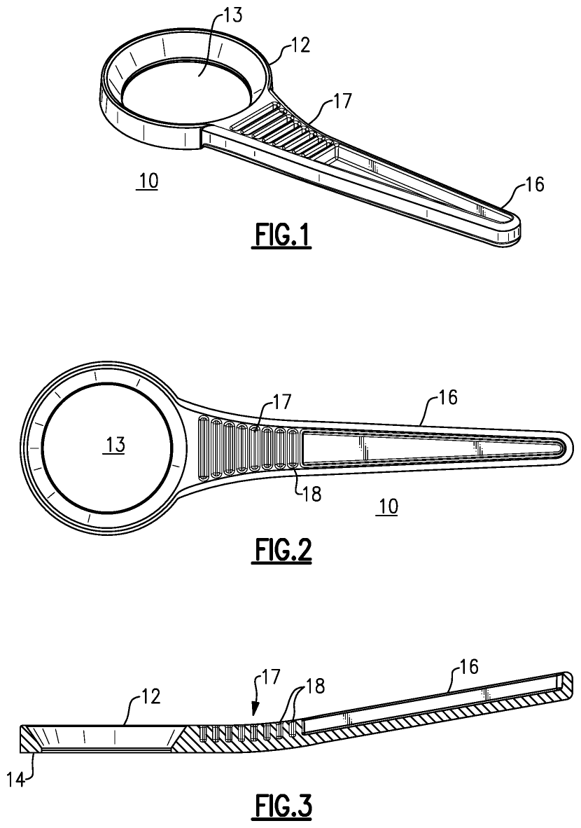

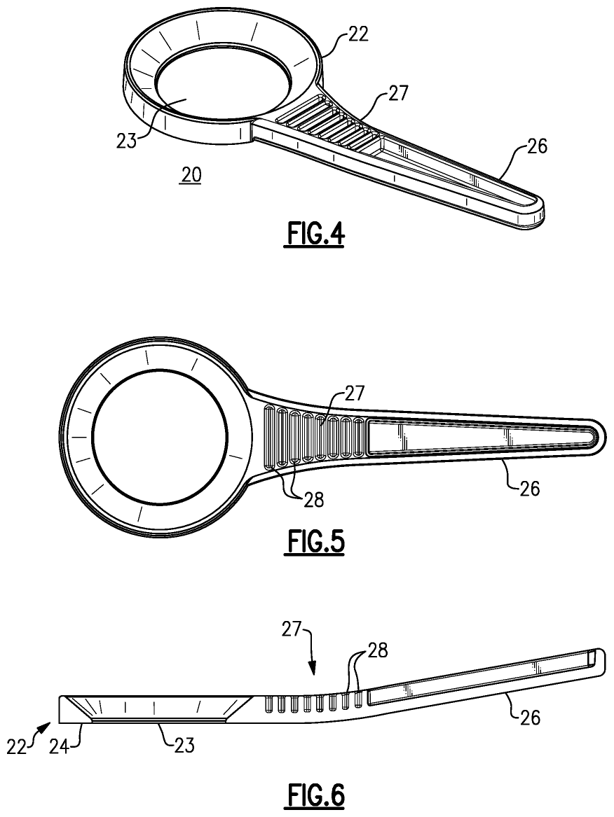

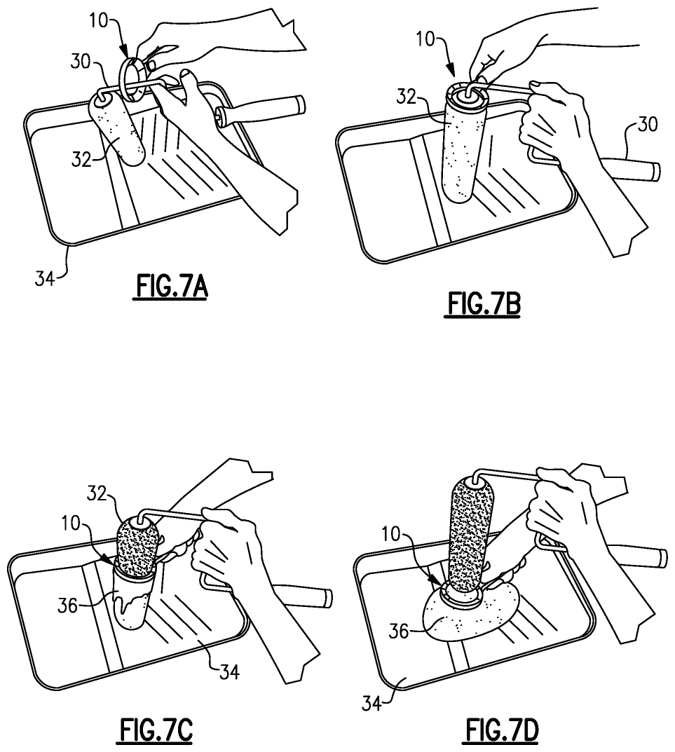

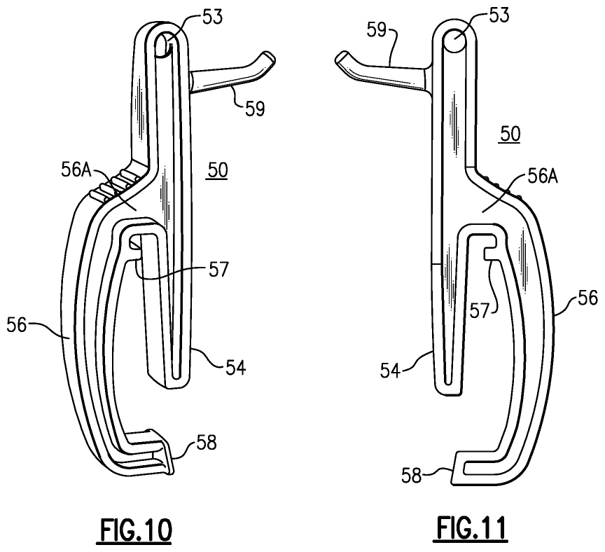

As discussed before, the present invention concerns painting of walls and other structural components of a building, e.g., in this case set of paint roller squeegees for different nap lengths of roller covers, and a set of paint brush holders of different heights that can clip onto the top of a standard plastic paint pail. Examples of a possible embodiment of the roller squeegees are shown in FIGS. 1 to 6, and examples of possible embodiments of the paint brush holders are shown in FIGS. 8 to 11. The painting tools can favorably be made of the same or similar plastic resins such as polypropylene or a similar material, which are resistant to bending but sufficiently yielding to resist breakage or shock damage. The squeegees and paint brush holders in the set can be of different dimensions. The tools may also be made of a different color or different appearance, i.e., the paint brush holders may all be the same distinctive color or may be of different colors for the different sizes, if desired.

An embodiment of the paint roller squeegee of this invention is shown in FIGS. 1 to 3.

The first squeegee 10 (FIGS. 1 to 3) is configured for cleaning roller covers with half-inch (½ inch) nap length. This squeegee 10 has a ring 12 with a circular inner opening 13 with a diameter of about 1.906 inches (i.e. about 1- 15/16 inches), a thickness of about 0.38 inches (about ⅜ inch), and with a flat or planar bottom surface 14. There is a sloping frustoconic inner surface from the top edge down to the circumference of the opening 13. This is a complete circular ring with no slits or gaps. A handle portion 16 extends from a proximal side of the ring 12 for a distance of about five to six inches, with a thumb grip area 17 that extends from the proximal side of the squeegee ring 12 about one-and-one-half inches of the handle portion 16. In this embodiment, there are a series of lateral troughs or channels 18 each extending most of the way across the handle portion. As seen in FIG. 2, the thumb grip area curves upwards to the handle portion 16 so that the handle portion is angled above the plane of the ring 12 (in this embodiment about ten degrees).

A similar squeegee 20 is shown in the perspective, plan, and elevation cross section of FIGS. 4, 5, and 6, respectively. This squeegee 20 has elements as described above but identified in the drawing with the same reference numbers but raised by ten. This squeegee is intended for the slightly smaller nap length of ⅜ inch, and the ring 22, handle 26 and thumb grip area 27 are dimensioned accordingly, smaller than the ones in the first embodiment. Here the ring diameter is about 1.82 inches (approximately 1- 13/16 inches), so as to accommodate the shorter nap on the ⅜ inch roller covers. In this embodiment also, the handle portion 28 slopes up at about a ten degree angle from the plane of the ring 22.

Other squeegees can be made for other nap lengths and scaled accordingly.

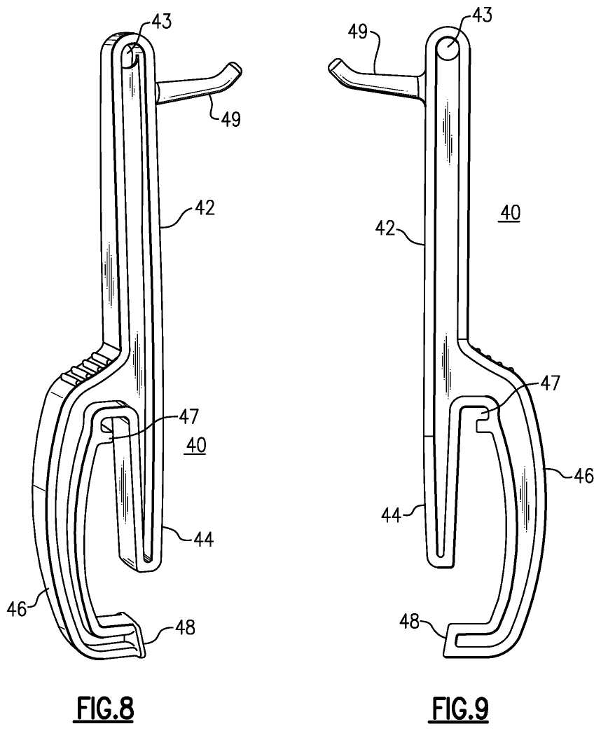

FIGS. 7A to 7D are referred to to explain the technique used in removing excess paint from the roller cover 32 of a given paint roller 30 by using the squeegee 10 (or 20). First (FIG. 7A) with the roller cover 32 in place on the paint roller 30, the painter grips the squeegee 10 by its handle 16, and pushes the squeegee ring over the handle of the paint roller 30 up to the paint roller cover. Then (FIG. 7B) he or she places the free end of the roller against the roller tray 34 and positions the squeegee so the flat side of the squeegee ring 10 is at the roller end of the cover 32. When the painter pushes the squeegee 10 down (FIG. 7C), the squeegee ring 12 forces the residual paint 36 out from the roller cover. After a full downward swipe with the squeegee (FIG. 7D) the residual paint from the cover forms a pool in the roller tray 34, and the painter can pour it back into the pail or paint can. A second pass or swipe of the squeegee is usually unnecessary.

Any paint that is still on the squeegee tool can easily be cleaned off.

Paint brushes of professional quality are expenses and need to be properly maintained, even during a painting job. If a paint brush is simply placed with the bristles down into the paint in a paint can or bucket, the bristles can bend or crush against the bottom of the paint can or paint bucket. Also, if the paint brush is left in open air, the paint on the bristles will quickly dry out, which can ruin an otherwise good paintbrush. Accordingly, the brush holder of this invention was developed to hold the brush with the bristle tips in the paint, but keep the bristles above the bottom of the paint can or other paint container.

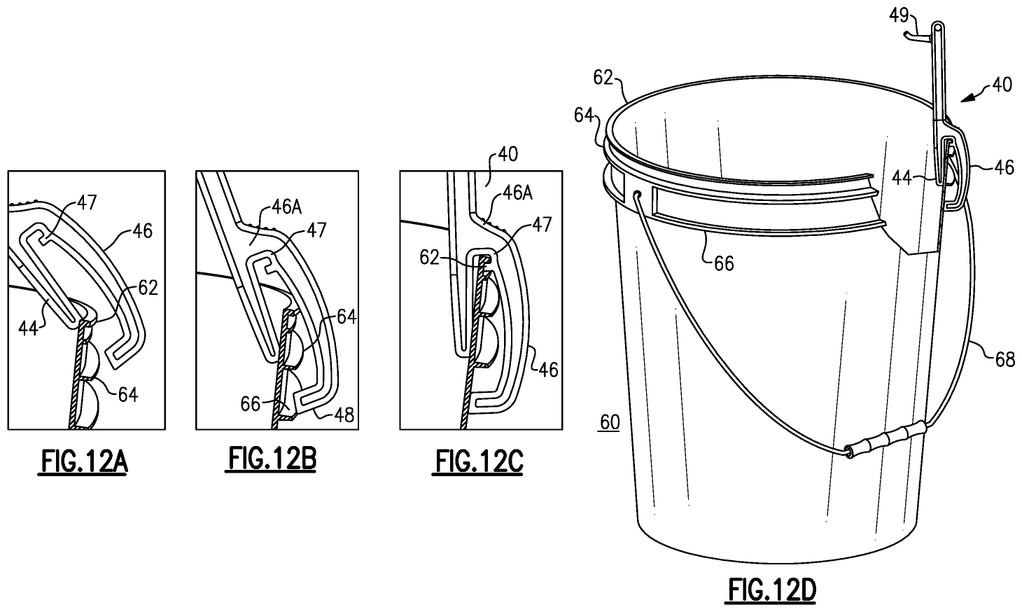

Embodiments of the paint brush holder(s) of the present invention are shown in FIGS. 8 and 9 and in FIGS. 10 and 11, respectively. The taller paint brush holder 40, for longer-hanled brushes, and which is shown in FIGS. 8 and 9 will be discussed first. The shorter embodiment of the paint brush holder 50, for shorter handled brushes, shown in FIGS. 10 and 11, is similar, with similar elements identified with similar reference numbers, but raised by 10, and will be briefly discussed thereafter.

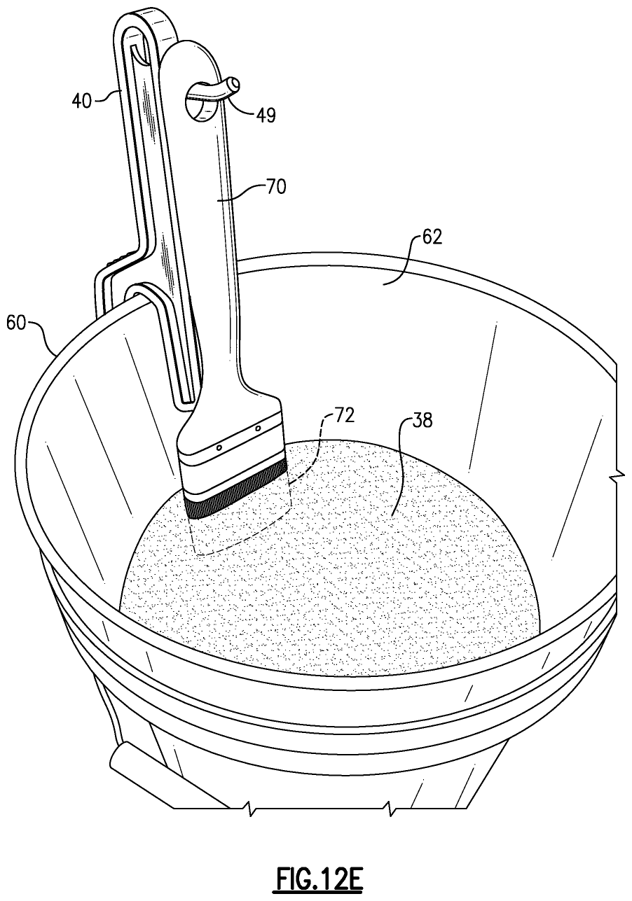

For the taller embodiment of paintbrush holder 40, as shown FIGS. 8 and 9, the holder 40 has an upper arm 42 that extends upward and is joined to a lower arm 44 that extends downward, i.e., into the paint pail or bucket. The upper arm 42 has a hole 43 near its upper end. A bowed outer arm 46 has a root portion 46A that extends out from the junction of the upper and lower arms 42, 44 and then downward, and then inward, ending at a foot or engaging surface 48. A short distance down from the root portion 46A there is a tooth 47 that projects laterally towards the lower arm 44. The lower arm fits inside the bucket (for example as shown in FIG. 12D) with the root portion 46A against the top rim of the bucket and the lower arm 44 inside the bucket and the for or engaging surface 48 against the inner surface of the bucket. The tooth 47 is configured to engage an outwardly projecting ridge 62 at the upper rim of th bucket.

At or near the upper end of the upper arm 42 a hook or hang peg 49 is configured to extend generally horizontally (over the inside of the paint bucket) for hanging a long-handle paint brush. There is typically a hole bored through the end of the paint brush handle, which fits over the hook 49. This can be of plastic, molded with the remainder of the paintbrush holder, or can be a metal insert that is molded into the arm 42 or inserted and attached after molding.

The corresponding embodiment of the paintbrush holder 50 for short handled paint brushes can be configured as shown in FIGS. 10 and 11, with an upper arm 52 with hole 53, lower arm 54 and bowed arm 56 with root portion 56A and tooth 57 and engaging surface 58, similar as to what is shown for the embodiment of FIGS. 8 and 9. A hook or hang-peg 59 extends horizontally from near the top of the upper arm 52.

As shown in both embodiments, the paint brush holder can be formed with inward portions of both sides recessed, to relieve some of the material and relieve some of the weight.

The placement of the paint brush holder (here the holder 40) onto the standard paint pail or bucket 60 is illustrated in FIGS. 12A, 12B, 12C and 12D. Installation of either of the paintbrush holders 40 or 50 onto the bucket would be the same or similar, and the installation onto other paint pails or buckets would also be the same or similar.

The paint brush holder 40 (or clip) can be slipped over the top rim 62 of the bucket 60 (FIG. 12A) with the lower arm 44 sliding along the inner side wall of the bucket, and with the engaging surface or foot 48 of the bowed outer arm 46 tilted away from the bucket sufficiently to clear all the bucket's reinforcing rings 64 and 66 (FIG. 12B). The root portion 44A of the arms 42, 46 lies on the upper rim ridge 62 of the bucket. The paintbrush holder 40 flexes the bucket 60 so that the tooth 47 snaps into place under the projecting ridge 62 of the bucket's top rim, and the engaging surface 48 pushes against the outer surface of the bucket (FIG. 12C). FIG. 12D shows the paintbrush holder 40 mounted onto the pail or bucket 80, here with a section of the upper rim cut away. The pin or hang peg 49 is shown extending over the open top of the bucket. The bail handle 40 for the bucket can be as shown.

FIG. 8E shows a paint brush 70 hanging from the holder 40, with the tips of the bristles in the paint 38 in the bucket 60.

With VOCs as low as 0.05 ml per gallon, to zero per gallon, when the brush is not in use, it must be submerged in paint, or it dries in minutes. This brush holder serves that purpose.

Most A-frame ladder painting and all extension ladder painting require a two-gallon bucket hooked on the side of the ladder at an angle. During times of adjusting safety ropes, maneuvering, scraping, etc., the brush holder allows the brush to hang neatly in the bucket. When cutting in walls and ceilings, the brush is moist and undamaged on the holder. While rolling, during ladder moves, adjusting drop cloths, painting woodwork, during down-time, breaks, phone calls, and the like, the brush is always in the holder on the paint pail.

The one-gallon storage paint can was never meant to paint out of Starting with a full or half can of paint results in carrying the brush in one hand and the can in the other. During moves and down-time, placing the can on the floor and the brush on the rim fills the rim with paint, resulting in the lid not sealing or opening properly, and also dripping paint onto the outside of the can. Instead, with this invention the painter paints out of the bucket and all the above-noted problems of the paint can are avoided. The painter simply clips the brush holder onto the two-gallon bucket, and fills the bucket with the desired amount of paint, and then cleans the rim of the one-gallon paint storage can and re-caps it.

The foregoing embodiments of this invention are intended to exhibit a few of many possible implementations of the present invention. The invention is not limited only to the precise embodiments as shown and described. Rather, many modifications and variations are possible within the scope of this invention as set forth in the appended claims.

I claims:

1. A paint roller squeegee for removing paint from a roller cover on a paint roller tool, comprising:
a squeegee ring having a circular opening, an annular planar lower side, and a conical annular surface meeting said lower surface to define said circular opening, the ring having a proximal side,
a handle portion extending from said proximal side of the squeegee ring and angled upward relative to said squeegee ring;
the squeegee ring being dimensioned such that the lower surface of the ring squeezes excess paint from the roller cover when said squeegee is pushed down over said roller cover.

2. A paint roller squeegee according to claim 1, wherein said squeegee ring and said handle portion are unitarily formed out of a suitable polymer.

3. A paint roller squeegee according to claim 2 wherein said polymer is resistant to adhesion to paint.

4. A paint roller squeegee according to claim 3 wherein said polymer is a polypropylene copolymer.

5. A paint roller squeegee according to claim 1 wherein said squeegee ring is a complete circular ring with no gaps.

6. A paint roller squeegee according to claim 1 wherein said handle portion has a main grip portion and a neck portion joining the main grip portion to the squeegee ring, said squeegee ring neck portion being formed with a series of parallel hollow recesses.

7. A paint roller squeegee according to claim 1 wherein said squeegee ring has an outer diameter of about three inches, and said opening has a diameter of about 1.9 inches.

8. A paint roller squeegee according to claim 1 wherein said squeegee ring has an outer diameter of about 2.4 to 2.5 inches and said opening has a diameter in a range of about 1-¾ inches to 1⅞ inches.

9. A paint roller squeegee according to claim 1 wherein said handle portion is angled upward substantially ten degrees.

10. A paint brush holder for mounting onto a top rim of a standard plastic paint bucket of the type that has a top reinforcing ring adjacent its upper edge and a series of spaced reinforcing rings formed on the outer surface of the paint bucket below the top reinforcing ring; the paint brush holder being adapted to fit onto the upper rim of the paint bucket and secured by engaging the top reinforcing ring and one or more of said spaced reinforcing rings of said paint bucket; with the paint brush holder comprising an upper vertical arm and extending along said vertical line when mounted onto the paint bucket;
a lower vertical arm joined to a lower end of said upper vertical arm and aligned along said vertical line of said upper vertical arm; and
a lower arcuate arm, having a root portion adjoined to one or both of said upper and lower vertical arms, and an arcuate portion descending from said root portion to a foot portion directed towards said vertical line and said lower arm; and a horizontal tooth portion protruding from said arcuate portion and spaced below said root portion, and extending part way towards said lower vertical arm; and
a brush holder peg extending from an upper portion of said upper arm.

11. A paint brush holder according to claim 10, wherein said upper vertical arm, said lower vertical arm and said lower arcutate are unitarily formed.

12. A paint brush holder according to claim 11, wherein said upper vertical arm, said lower vertical arm and said lower arcuate are unitarily formed of a rigid or semi-rigid polypropylene copolymer.

13. A paint brush holder according to claim 12, wherein said brush holder peg is unitarily formed with said upper vertical arm.

14. A paint brush holder according to claim 11 wherein said brush holder peg is formed of a metal insert molded into said upper vertical arm.

15. A paint brush holder according to claim 10, wherein said foot portion extends laterally a distance sufficient to contact the outer surface of said paint bucket.

16. A paint brush holder according to claim 10 in which the length of the upper vertical arm from a lower edge of the root portion to the position of the brush holder peg is between substantially three and four inches.

17. A paint brush holder according to claim 10 in which the length of the upper vertical arm from a lower edge of the root portion to the position of the brush holder peg is between substantially one and two-and-one-half inches.

18. A paint brush holder and roller cover scraper kit comprising
A first and a second paint roller squeegee for removing paint from a roller cover on a paint roller tool, each comprising:
a squeegee ring having a circular opening, an annular planar lower side, and a conical annular surface meeting said lower surface to define said circular opening, the ring having a proximal side,
a handle portion extending from said proximal side of the squeegee ring and angled upward relative to said squeegee ring;
the squeegee ring being dimensioned such that the lower surface of the ring squeezes excess paint from the roller cover when said squeegee is pushed down over said roller cover;
the first paint roller squeegee ring has an outer diameter of about three inches, and said opening thereof has a diameter of about 1.9 inches; and the second paint roller squeegee ring has an outer diameter of about 2.4 to 2.5 inches and said opening thereof has a diameter of about 1-14¾ inches to 1⅞ inches;
and at least a first and a second paint brush holder for for mounting onto a top rim of a standard plastic paint bucket of the type that has a top reinforcing ring adjacent its upper edge and a series of spaced reinforcing rings formed on the outer surface of the paint bucket below the top reinforcing ring; the first and second paint brush holders being adapted to fit onto the upper rim of the paint bucket and secured by engaging the top reinforcing ring and one or more of said spaced reinforcing rings of said paint bucket; with the first and second paint brush holders each comprising an upper vertical arm and extending along said vertical line when mounted onto the paint bucket;
a lower vertical arm joined to a lower end of said upper vertical arm and aligned along said vertical line of said upper vertical arm; and
a lower arcuate arm, having a root portion adjoined to one or both of said upper and lower vertical arms, and an arcuate portion descending from said root portion to a foot portion directed towards said vertical line and said lower arm; and a horizontal tooth portion protruding from said arcuate portion and spaced below said root portion, and extending part way towards said lower vertical arm; and
a brush holder peg extending from an upper portion of said upper arm; wherein
In the first brush holder, the length of the upper vertical arm from a lower edge of the root portion to the position of the brush holder peg is between substantially three and four inches, and in the second brush holder, the length of the upper vertical arm from a lower edge of the root portion to the position of the brush holder peg is between substantially one and two-and-one-half inches.

19. A paint brush holder and roller cover scraper kit according to claim 18, wherein each of said first and second brush holders and each of said first and second roller squeegees is unitarily formed of a polypropylene copolymer.

20. A paint brush holder and roller cover scraper kit according to claim 18 each of said first and second paint roller squeegees have its respective handle portion formed of a main grip portion and a neck portion joining the main grip portion to the squeegee ring, said neck portion being formed with a series of parallel hollow recesses.
